(19) United States
(12) Patent Application Publication
(10) Pub. No.: US 2025/0292087 A1
(43) Pub. Date: Sep. 18, 2025

(54) INTERACTION NETWORKS

(71) Applicant: GDM Holding LLC, Mountain View, CA (US)

(72) Inventors: Peter William Battaglia, London (GB); Razvan Pascanu, Letchworth Garden City (GB)

(21) Appl. No.: 19/221,869

(22) Filed: May 29, 2025

Related U.S. Application Data
(63) Continuation of application No. 16/303,623, filed on Nov. 20, 2018.
(60) Provisional application No. 62/339,703, filed on May 20, 2016.

(51) Int. Cl. G06N 3/08; G06N 3/045

(52) U.S. Cl. CPC G06N 3/08; G06N 3/045

(57) ABSTRACT

Methods, systems, and apparatus, including computer programs encoded on computer storage media for predicting future states objects and relations in complex systems. One method includes receiving an input comprising states of multiple receiver entities and multiple sender entities, and attributes of multiple relationships between the multiple receiver entities and multiple sender entities; processing the received input using an interaction component to produce as output multiple effects of the relationships between the multiple receiver entities and multiple sender entities; and processing the states of the multiple receiver entities and multiple sender entities, and the multiple effects of the relationships between the multiple receiver entities and multiple sender entities using a dynamical component to produce as output a respective prediction of a subsequent state of each of the multiple receiver entities and multiple sender entities.

### CROSS-REFERENCE TO RELATED APPLICATION

This patent application is a continuation (and claims the benefit of priority under 35 USC 120) of U.S. patent application Ser. No. 16/303,623, filed Nov. 20, 2018, which is a National Stage Application under 35 U.S.C. 371 of International Application No. PCT/US2017/033702, filed May 19, 2017, which claims priority to U.S. Provisional Patent Application No. 62/339,703, filed May 20, 2016, the entire contents of which are hereby incorporated by reference.

### BACKGROUND

This specification relates to neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes an interaction network for analyzing current states and predicting future states of interacting objects in complex systems. The interaction network includes multiple neural networks that are trained to receive data representing current states of objects at time t, together with data representing their interactions. The neural networks process the received data to generate as output data representing predicted subsequent states of the objects at time t+1, e.g., predicted consequences of the interactions between the objects.

In general, one innovative aspect of the subject matter described in this specification can be embodied in a computing system that includes an interaction component configured to: receive as input (i) states of one or more receiver entities and one or more sender entities, and (ii) attributes of one or more relationships between the one or more receiver entities and one or more sender entities; and process the received input to produce as output multiple effects of the relationships between the one or more receiver entities and one or more sender entities; a dynamical component configured to: receive as input (i) the states of the one or more receiver entities and one or more sender entities, and (ii) the multiple effects of the relationships between the one or more receiver entities and one or more sender entities; and process the received input to produce as output a respective prediction of a subsequent state of each of the one or more receiver entities and one or more sender entities.

Other embodiments of this aspect include corresponding methods, apparatus, and computer programs recorded on one or more computer storage devices, each configured to perform the actions of the methods. A system of one or more computers can be configured to perform particular operations or actions by virtue of software, firmware, hardware, or any combination thereof installed on the system that in operation may cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations a receiver entity comprises an entity that is affected by one or more sender entities through one or more respective relationships.

In some implementations a relational attribute of a relationships between a receiver entity and a sender entity describes the relationships between the receiver entity and sender entity.

In some implementations the (i) states of the one or more receiver entities and one or more sender entities, and (ii) relational attributes of the one or more relationships between the one or more receiver entities and one or more sender entities are represented as an attributed directed multigraph comprising multiple nodes for each entity and one or more directed edges for each relationships indicating an influence of one entity on another.

In some implementations the one or more relationships between the one or more receiver entities and one or more sender entities comprise binary interactions between a receiver entity and a sender entity, and each binary interaction is represented by a 3-tuple comprising (i) an index of a respective receiver entity, (ii) an index of a respective sender entity, and (iii) a vector containing relational attributes of the respective receiver entity and respective sender entity.

In some implementations the one or more relationships between the one or more receiver entities and one or more sender entities comprise high-order interactions, and each high-order interaction is represented by a (2m−1)-tuple, where m represents the order of the interaction.

In some implementations the interaction component comprises a first neural network and the dynamical component comprises a second neural network, optionally wherein the first neural network comprises a first multilayer perceptron (MLP) and the second neural network comprises a second MLP.

In some implementations processing the received input to produce as output multiple effects of the relationships between the one or more receiver entities and one or more sender entities comprises: defining (i) a state matrix as a matrix whose i-th column represents a state of entity i, (ii) a receiver matrix as a N_{O}×N_{R} matrix, where N_{O} represents the total number of entities and N_{R} represents the total number of relationships, and wherein each column of the receiver matrix contains zero entries except for the position of an entity that is a receiver of the corresponding relationships, and (iii) a sender matrix as a N_{O}×N_{R} matrix, wherein each column of the sender matrix contains zero entries except for the position of an entity that is a sender of the corresponding relationships; multiplying the defined receiver matrix and the defined sender matrix by the defined state matrix; concatenating the multiplied matrices to generate an input for the first MLP; processing the input using the first MLP to produce as output multiple effects of the relationships between the one or more receiver entities and one or more sender entities, wherein the produced output comprises an effect matrix whose columns represent the multiple effects of the relationships between the one or more receiver entities and the one or more sender entities.

In some implementations the relationships between the one or more receiver entities and one or more sender entities comprise relationships of different types, and concatenating the multiplied matrices further comprises concatenating the multiplied matrices and a matrix representing the relationships of different types to generate an input for the second MLP.

In some implementations processing the received input to produce as output a respective prediction of the state of each of the one or more receiver entities and one or more sender entities comprises: multiplying the effect matrix with a transpose of the defined receiver matrix; concatenating the multiplied effect matrix with the transpose of the defined receiver matrix with the defined state matrix to generate an input for the second MLP; processing the input using the second MLP to produce as output a respective prediction of a subsequent state of each of the one or more receiver entities and one or more sender entities.

In some implementations during a system training process the sender and receiver matrices are constant.

In some implementations the number of output multiple effects of the relationships between the one or more receiver entities and one or more sender entities is equal to the number of input relationships between the one or more receiver entities and one or more sender entities.

In some implementations processing the received input to produce as output a respective prediction of a subsequent state of each of the one or more receiver entities and one or more sender entities comprises aggregating the received multiple effects of the relationships between the one or more receiver entities and one or more sender entities using one or more commutative and associative operations, wherein the one or more commutative and associative operations optionally comprise element-wise summations.

In some implementations the produced respective prediction of the subsequent state of each of the one or more receiver entities and one or more sender entities comprises multiple entity states corresponding to subsequent receiver entity states and subsequent sender entity states.

In some implementations the system is further configured to analyze the produced respective prediction of the subsequent state of each of the one or more receiver entities and one or more sender entities to predict global properties of the one or more receiver entities and one or more sender entities.

In some implementations the interaction component utilizes a first function approximator to model relationships between entities, and the dynamical component utilizes a second function approximator to model the state of the environment in which the entities reside.

In some implementations the interaction component and dynamical component are trained independently.

In some implementations the interaction component and dynamical component are trained end to end using a gradient based optimization technique.

The subject matter described in this specification can be implemented in particular embodiments so as to realize one or more of the following advantages.

An interaction network, as described in this specification, provides a general-purpose, learnable physics engine, and provides a powerful framework for determining properties and predictions of objects and relationships between objects in a variety of complex real-world domains.

Interaction networks, as described in this specification, explicitly separate analyzing relationships between entities or objects from analyzing the entities or objects. This enables interaction networks to automatically generalize their learning across variable numbers of arbitrarily ordered objects and relations, and also to recompose their knowledge of entities and interactions in multiple different ways. Interaction networks take relations as explicit input, allowing them to selectively process different potential interactions for different input data, rather than being forced to consider every possible interaction or those imposed by a fixed architecture. Accordingly, when compared to conventional neural networks, interaction networks as described herein can provide greater flexibility in terms of their processing capabilities, and can help to reduce the computational burden involved in processing multiple sets of (different) input data.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an illustration of an example process for generating predictions about a future state of a system of interacting objects.

FIG. 2 is a block diagram of an example interaction network.

FIG. 3 is a flow diagram of an example process for simulating a physical system.

FIG. 4 is a flow diagram of an example process for processing an input representing a system of objects and relations to determine effects of relationships between the objects.

Like reference numbers and designations in the various drawings indicate like elements.

### DETAILED DESCRIPTION

Representing and reasoning about objects, relations and physics is a central domain of human common sense knowledge, and a basic and important aspect of intelligence. Many everyday problems, such as predicting what will happen next in a physical environment or inferring underlying properties of complex scenes, are challenging because their elements can be composed in combinatorially many possible arrangements. Such problems can be solved by decomposing the scenario into distinct objects and relations, and reasoning about the consequences of their interactions and dynamics.

An interaction network is a model that can analyze data representing a system of objects and relations between objects to generate predictions of future states of the objects and relations between the objects. Interaction networks combine three approaches: structured models, simulation, and deep learning. Structured models are used to exploit rich, explicit knowledge of relations among objects, independent of the objects themselves, supporting general-purpose reasoning across diverse contexts. Simulation provides an effective method for approximating dynamical systems, predicting how the elements in a complex system are influenced by interactions with one another, and by the dynamics of the system. Deep learning is used to couple computing architectures with efficient optimization algorithms to provide highly scalable learning and inference in challenging real-world settings.

Interaction networks explicitly separate analysis of relations between objects from analysis of objects themselves, and assign tasks to distinct models that are fundamentally object- and relation-centric, and independent of observation modality and task specification. This enables interaction networks to automatically generalize their learning across variable numbers of arbitrarily ordered objects and relations, and also recompose their knowledge of objects and interactions in novel and combinatorially many ways. The interaction networks take relationships between objects as explicit input, allowing the interaction networks to selectively process different potential interactions for different input data, rather than being forced to consider every possible interaction or those imposed by a fixed architecture.

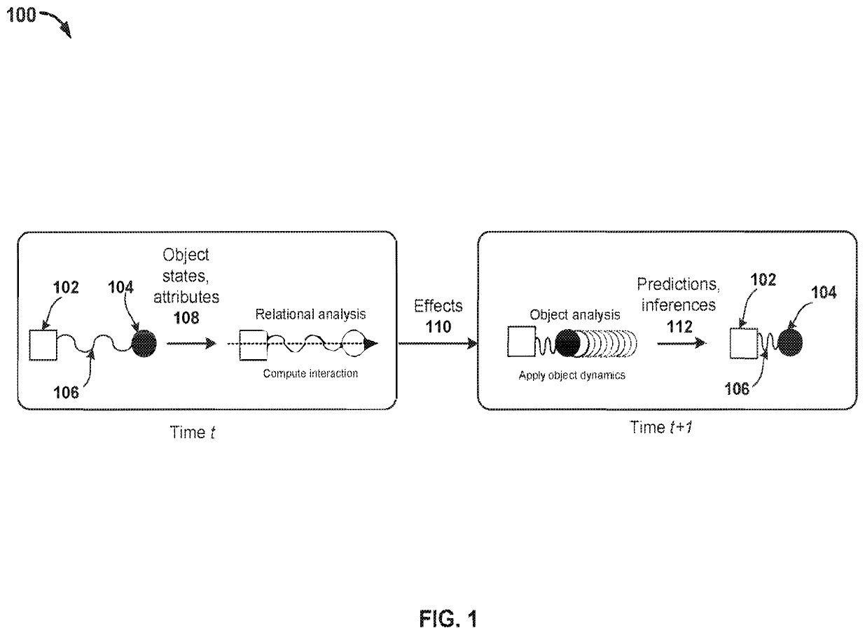

FIG. 1 shows an illustration 100 of an example process for generating predictions about a future state of a system of interacting objects using an interaction network. The illustration shows how information representing a current state of two objects and their relationship can be processed to predict a future state, i.e., the dynamics, of the two objects. In particular, the illustration shows how a future state at time t+1 of an example fixed object 102 and an example freely moving object 104 that are attached by a spring 106 can be predicted.

To predict the dynamics of a single object o, an object-centric function fₒ is used. The object-centric function takes the object's state, oₜ at time t as input, and outputs a future state, Oₜ₊₁. If two or more objects are governed by the same dynamics, fₒ may be applied to each, independently, to predict their respective future states. However, if the objects interact with one another, as in the case of the fixed object 102 and freely moving object 104 illustrated in FIG. 1, fₒ is insufficient because it does not capture their relationship. For example, two objects may sometimes be related through one or more directed relationships that causes one of the objects to influence the other. For example, as illustrated in FIG. 1, the fixed object 102 is related to the freely moving mass 104 through the spring 106. The fixed object 102 influences the behavior of the freely moving object 104 through the spring 106.

The effect of the interaction between two objects, eₜ₊₁, can be predicted by a relation-centric function, f_{R}. The relation-centric function f_{R} takes as input the state of a first object o₁ and state of a second object, o₂, as well as attributes of their relationship, r:

$${e}_{t + 1} = {f}_{R} ( {o}_{1 , t} , {o}_{2 , t} , r ) .$$

The object-centric function fₒ may then be modified so that it can take both eₜ₊₁ and the receiver's current state, o_{2,t} as input, enabling the interaction to influence its future state, o_{2,t+1},

$${o}_{2 , t + 1} = {f}_{O} ( {o}_{2 , t} , {e}_{t + 1} ) .$$

For example, the effects 110 of the interaction between the fixed object 102 and the freely moving mass 104 can be predicted or inferred 112 using a relation-centric function that takes as input the states and attributes 108 of the objects 102, 104, e.g., the spring constant of the spring 106. As shown in FIG. 1, the example process may be used to predict that a freely moving mass 104 attached to a fixed object 102 via a stretched spring 106 at time t will move towards the fixed object 102, thus contracting the spring 106, at a subsequent time step t+1.

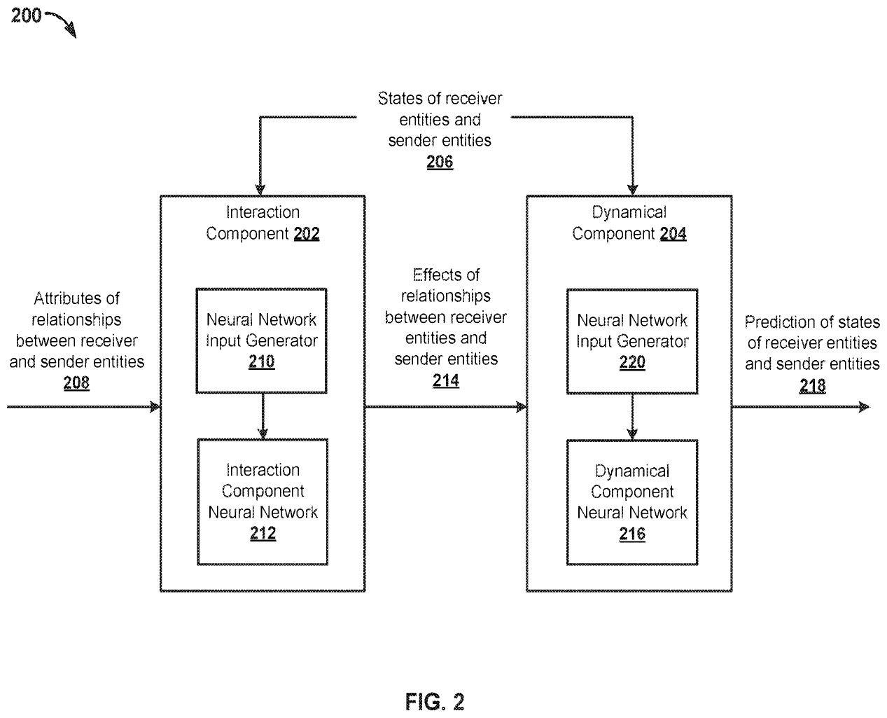

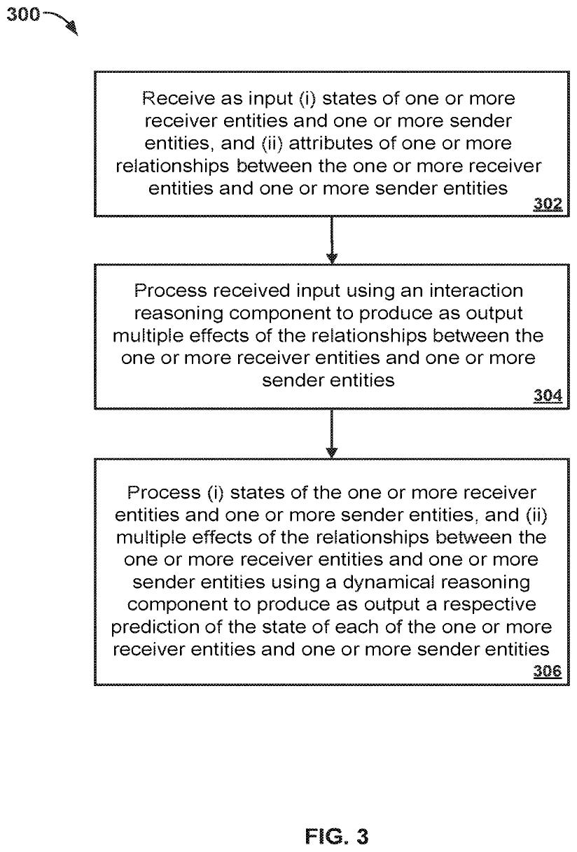

The above described formulation can be expanded to larger and more complex systems, e.g., systems including multiple interacting objects, by representing them as a graph, G=<O, R>, where the nodes, O, correspond to the objects, and the edges, R, to the relations between the objects. The graph, G, may be an attributed, directed multigraph, i.e., a graph that may include parallel edges. In some implementations there may be multiple distinct relations between two objects, e.g., rigid and magnetic interactions. These multiple relations can be expressed as parallel edges between two nodes. For a system with N_{O} objects and N_{R} relations, the inputs to the interaction network may be given by

$$O = {\{ {o}_{j} \}}_{j = 1 , … , {N}_{O}} ,$$

$$R = {\{ {〈 i , j , {r}_{k} 〉}_{k} \}}_{k = 1 , … , {N}_{R}} where i \neq j , 1 \leq i , j \leq {N}_{O} , X = {\{ {x}_{j} \}}_{j = 1 , … , {N}_{O}}$$

where O represents the states of each object, the triplet, <i, j, rₖ>ₖ, represents the k-th relation in the system, from sender, oᵢ, to receiver, oj, with relation attribute, rₖ, and X represents external effects, such as active control inputs or gravitational acceleration. External effects are defined as not being part of the system, and are applied to each object separately. An example interaction network is described in more detail below with reference to FIGS. 2 and 3.

FIG. 2 is a block diagram of an example interaction network 200. The interaction network 200 is an example of a system implemented as computer programs on one or more computers in one or more locations, in which the systems, components, and techniques described below can be implemented.

The interaction network 200 is a system that can be used to dynamically predict how entities, e.g., elements of a physical system or a knowledge graph, in systems interact and infer properties of the system. The interaction network 200 includes an interaction component 202 and a dynamical component 204. The interaction component 202 includes an interaction component neural network 212, e.g., a first multilayer perceptron (MLP). The dynamical component 204 includes a dynamical component neural network 216, e.g., a second MLP.

The interaction component 202 is configured to receive as input data 206 representing states of one or more receiver entities and one or more sender entities. A receiver entity is an entity that is affected by one or more sender entities through one or more respective relationships. Relationships between entities may include dependencies or connections in a knowledge graph, springs or collisions between elements of a physical system. For example, as described above with reference to FIG. 1, a receiver entity may include a freely moving mass and a sender entity may include a fixed object that is attached to the freely moving mass via a spring.

The interaction component 202 is further configured to receive as input data 208 representing attributes of one or more relationships between the one or more receiver entities and one or more sender entities. For example, as described above with reference to FIG. 1, an attribute of a relationship between a freely moving mass and a fixed object that are connected by a spring may include a value of the spring constant.

In some implementations the received input data 206, 208 may be represented as an attributed directed multigraph G. For example, the interaction network 200 may be configured to receive input data 206, 208 representing an attributed directed multigraph G. For example, the input data 206, 208 may include a data structure that represents a graph, e.g., an adjacency list or adjacency matrix. Alternatively, the interaction network 200 may be configured to receive input data 206, 208 and to process the received input data to generate a corresponding attributed directed multigraph G, e.g., to generate a data structure that represents a graph. The multigraph G may include multiple nodes that represent respective entities and one or more edges representing relationships between the entities. The edges may be directed edges that indicate an influence of one entity on another.

The interaction component 202 is configured to process the received inputs 206, 208 to produce as output data 214 representing effects of the relationships between the one or more receiver entities and one or more sender entities. For example, as illustrated above with reference to FIG. 1, data representing an effect of the taut spring 106 connecting the fixed object 102 and freely moving mass 106 may include data indicating that the taut spring will contract.

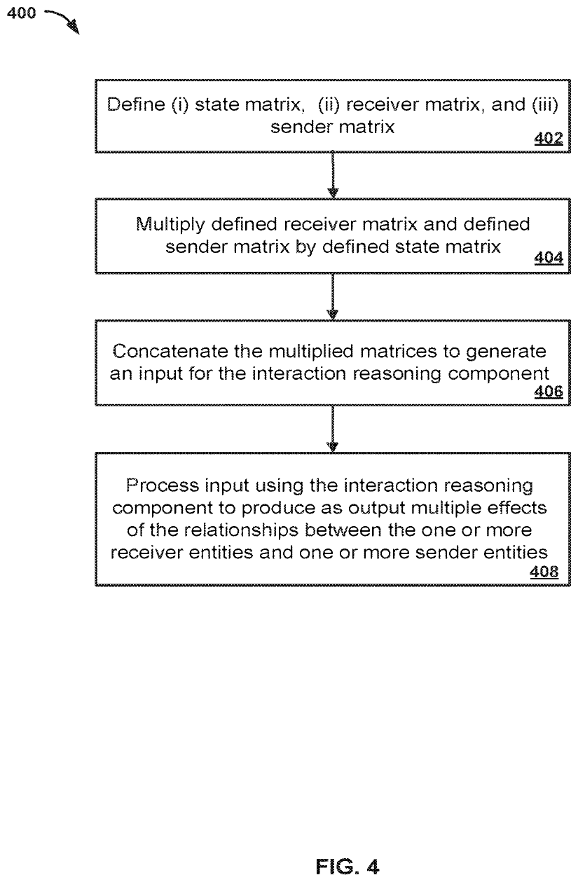

In some implementations the interaction component 202 may be configured to process the received inputs 206, 208 to generate an input for the interaction component neural network 212, e.g., using neural network input generator 210. The interaction component neural network 212 may then process the generated neural network input to generate, as output, the data 214 representing effects of the relationships between the one or more receiver entities and one or more sender entities. Processing interaction network input data to generate an input for a neural network included in an interaction component is described in more detail below with reference to FIGS. 3 and 4.

The interaction component neural network 212 may be a neural network that has been trained on suitable training data to predict effects of relationships between receiver entities and sender entities. For example, the training data may include example pairs of (i) relationships between receiver entities and sender entities, e.g., represented by a matrix, and (ii) known effects of the relationships. In some implementations the interaction component neural network 212 and the dynamical component neural network 216 may be trained end to end using a gradient based optimization technique, e.g., stochastic gradient descent.

The dynamical component 204 is configured to receive as input data 214 representing effects of the relationships between the one or more receiver entities and one or more sender entities, and input data 206 representing states of one or more receiver entities and one or more sender entities. The dynamical component 204 is configured to process the received input data 214 to generate as output data 218 representing respective predictions of the states of the one or more receiver entities and one or more sender entities. For example, as illustrated above with reference to FIG. 1, data representing a prediction of the states of the freely moving mass 104 and fixed object 102 may include data indicating that the freely moving mass 104 will move towards the fixed object 102, contracting the spring 106.

In some implementations the dynamical component 204 may be configured to process the received inputs 206, 214 to generate an input for the dynamical component neural network 216, e.g., using neural network input generator 220. The dynamical component neural network 216 may then process the generated neural network input to generate, as output, the data 218 representing respective predictions of the states of the one or more receiver entities and one or more sender entities. Processing dynamical component input data to generate an input for a neural network included in the dynamical component is described in more detail below with reference to FIGS. 3 and 4.

The dynamical component neural network 216 may be a neural network that has been trained on suitable training data to predict future states of receiver and sender entities. For example, the training data may include example pairs of (i) current entity states and effects of their interactions, e.g., represented by a matrix, and (ii) known future states. In some implementations the interaction component neural network 212 and dynamical component neural network 216 may be trained end to end using a gradient based optimization technique, e.g., stochastic gradient descent. In some implementations the dynamical component neural network 216 and interaction component neural network 212 are trained independently.

The interaction network 200 may be applied to a variety of settings, including traffic flow analysis, e.g., where entities include vehicles, relationships include interactions between vehicles, and the output data 218 includes data predicting future states of a highway or multiple roads, or logistics or social media settings, e.g., where entities include members of a social media site, relationships include interactions between members, and the output data 218 includes data predicting future connections between members to provide members with suggested connections/friendships. In addition, the interaction network 200 provides a learnable physics engine that may be used to simulate certain physical systems, such as rigid body dynamics (including collision detection), soft body dynamics, and fluid dynamics. Other example use cases are in the domains of computer graphics, video games and film.

In some implementations the interaction network 200 may include, or be in data communication with, an analyzing component that is configured to analyze data representing predictions of the states of the one or more receiver entities and one or more sender entities, e.g., output data 218. For example, the interaction network 200 may include an additional neural network, e.g., a MLP, that is configured to receive as input data representing predictions of the states of receiver entities and sender entities. The additional neural network may be configured to process the received input to generate as output data representing inferred properties about the system of entities. For example, the output data 218 may be analyzed to determine or predict global properties of the one or more receiver entities and one or more sender entities, e.g., a potential energy of a physical system or a total amount of traffic on a highway or collection of roads.

In some implementations the analyzing component may be configured to preprocess data P representing predictions of the states of the one or more receiver entities and one or more sender entities before the data is provided to the additional neural network. For example, the analyzing component may be configured to apply an aggregation function g to the data P. The aggregation function g may perform an elementwise summation across the columns of the matrix P to return a Dₚ length vector \tilde{P}. The vector \tilde{P} may then be provided to the additional neural network as input.

FIG. 3 is a flow diagram of an example process 300 for simulating a physical system. For convenience, the process 300 will be described as being performed by a system of one or more computers located in one or more locations. For example, an interaction network, e.g., the interaction network 200 of FIG. 2, can perform the process 300.

The system receives an input including (i) states of one or more receiver entities and one or more sender entities, and (ii) attributes of one or more relationships between the one or more receiver entities and one or more sender entities step (302). In some implementations a receiver entity includes an entity that is affected by one or more sender entities through one or more respective relationships. A relational attribute of a relationship between a receiver entity and a sender entity describes the relationships between the receiver entity and sender entity. Example entities include entities represented in a knowledge graph, or elements of a physical system such as moving or stationary objects. Generally, the entities may include any data points with a topology that describes relationships between the data points. For example, the entities may include data points representing pixels in an image. In this example, the topology describing the relationships between the data points represents the spatial proximity of the pixels in the image. Relationships between entities may include dependencies or connections in a knowledge graph, springs or collisions between elements of a physical system, or dependencies or connections between data points.

For example, in some implementations the one or more relationships between the one or more receiver entities and one or more sender entities may include binary interactions between a receiver entity and a sender entity, where each binary interaction is represented by a 3-tuple including (i) an index of a respective receiver entity, (ii) an index of a respective sender entity, and (iii) a vector containing relational attributes of the respective receiver entity and respective sender entity. As another example, the one or more relationships between the one or more receiver entities and one or more sender entities may include high-order interactions, where each high-order interaction is represented by a (2m−1)-tuple, where m represents the order of the interaction. For example, in some cases two sender entities may affect a same receiver entity through two respective interactions. This may be described as a higher-order interaction, e.g., an interaction of the order 3, and may be represented by a 5-tuple including (i) an index of the receiver entity, (ii) an index of the first sender entity, (iii) an index of the second sender entity, (iv) a vector containing relational attributes of the receiver entity and the first sender entity, and (v) a vector containing relational attributes of the receiver entity and the second sender entity.

The states of the one or more receiver entities and one or more sender entities and relational attributes of the one or more relationships between the one or more receiver entities and one or more sender entities may be represented as an attributed directed multigraph including multiple nodes for each entity and one or more directed edges for each relationships indicating an influence of one entity on another. By representing the states of the one or more receiver entities and one or more sender entities and the relational attributes of the one or more relationships between the one or more receiver entities and one or more sender entities, the system is able to take advantage of structured approaches, such as handling variable numbers of entities in arbitrary order and transferring what has been learned to novel tasks.

The system processes the received input to produce as output multiple effects of the relationships between the one or more receiver entities and one or more sender entities (step 304). In some implementations the number of output multiple effects of the relationships between the one or more receiver entities and one or more sender entities is equal to the number of input relationships between the one or more receiver entities and one or more sender entities. Determining multiple effects of relationships between one or more receiver entities and one or more sender entities is described in more detail with reference to FIG. 4 below.

The system processes (i) the states of the one or more receiver entities and one or more sender entities, and (ii) the multiple effects of the relationships between the one or more receiver entities and one or more sender entities to produce as output a respective prediction of the state of each of the one or more receiver entities and one or more sender entities (step 306). In some implementations processing the received input may include aggregating the received multiple effects of the relationships between the one or more receiver entities and one or more sender entities using one or more commutative and associative operations, where the one or more commutative and associative operations may include element-wise summations.

For example, the system may apply an aggregation function a to data G representing the objects and relationships, data X representing external effects applied to each of the objects, and data E representing the multiple effects of the relationships between the objects. The aggregation function a may compute a matrix product \tilde{E}=ERᵣ^{T}, whose j-th column is equivalent to an elementwise summation across all effects whose corresponding relation has receiver object j. The aggregation function a may then concatenate \tilde{E} with data representing the objects O and X:

$$a ( G , X , E ) = [ O ; X ; \tilde{E} ] = C$$

where C is a matrix whose columns represent object states, external effects and per-object aggregate interaction effects.

The generated matrix C may be processed by a dynamical component, as described above with reference to FIG. 1, to generate an output matrix P representing predictions of the states of each of the one or more receiver entities and one or more sender entities. For example, the system may apply a MLP to each of the columns of C to generate respective vectors pⱼ of length Dₚ. The vectors pⱼ may be concatenated to produce the matrix P.

The produced respective prediction of the state of each of the one or more receiver entities and one or more sender entities includes multiple entity states corresponding to subsequent receiver entity states and subsequent sender entity states.

In some implementations the system may further analyze the produced respective prediction of the state of each of the one or more receiver entities and one or more sender entities to predict global properties of the one or more receiver entities and one or more sender entities. For example, the system may use an aggregation function g to perform an elementwise summation across the columns of the matrix P to return a Dₚ length vector \tilde{P}. The vector \tilde{P} may be further processed by an MLP which generates as output a Da length vector q that represents a global property of the system of objects or entities.

FIG. 4 is a flow diagram of an example process 400 processing an input representing a system of objects and relations to determine effects of relationships between the objects. For convenience, the process 400 will be described as being performed by a system of one or more computers located in one or more locations. For example, an interaction network, e.g., the interaction network 200 of FIG. 2, can perform the process 400.

The system defines (i) a state matrix, (ii) a receiver matrix, and (iii) a sender matrix (step 402). The state matrix O is defined as a Dₛ×N_{O} matrix where N_{O} represents the total number of objects. Each column of the state matrix O corresponds to a respective object's state vector of length Dₛ.

The receiver matrix Rᵣ is defined as a N_{O}×N_{R} matrix, where N_{R} represents the total number of relationships between the objects. In some implementations the receiver matrix may be a binary matrix, i.e., a matrix whose entries are either 0 or 1. In these implementations, each column of the receiver matrix Rᵣ may contain zero entries except for the position of an object that is a receiver of the corresponding relationships. As an example, in the case where the system of objects and relations includes three objects o₁, o₂ and o₃, with o₁ and o₃ influencing or interacting with o₂, an example receiver matrix may be given by

$${R}_{r} = ( \begin{matrix}0 & 0 \\ 1 & 1 \\ 0 & 0\end{matrix} ) .$$

The sender matrix Rₛ is defined as a N_{O}×N_{R} matrix. In some implementations the sender matrix may be a binary matrix. In these implementations, each column of the sender matrix Rₛ contains zero entries except for the position of an object that is a sender of the corresponding relationships. Continuing the example above, an example sender matrix may be given by

$${R}_{s} = ( \begin{matrix}1 & 0 \\ 0 & 0 \\ 0 & 1\end{matrix} ) .$$

The system may further define an attribute matrix Rₐ. The attribute matrix Rₐ is defined as a D_{R}×N_{R} matrix. Each column of the attribute matrix corresponds to a relation between the objects and represents the respective relation's attributes via a D_{R} length vector.

The system multiplies the defined receiver matrix and the defined sender matrix by the defined state matrix (step 404). In some implementations the system multiplies the receiver matrix with the state matrix and the sender matrix with the state matrix using a marshalling function m that is configured to compute the matrix products ORᵣ and ORₛ

The system concatenates the multiplied matrices ORᵣ and ORₛ to generate an input B for the interaction component (step 406). In some implementations the system may further concatenate the matrices ORᵣ and ORₛ with the attribute matrix Rₐ. For example, the marshalling function m described above with reference to step 404 may multiply the defined receiver and sender matrices by the defined state matrix and further concatenate the multiplied matrices with the attribute matrix, e.g., m(G)=[ORᵣ; ORₛ; Rₐ]=B. The generated input B is a (2Dₛ+D_{R})×N_{D} matrix, whose columns represent interaction terms for the N_{R} relations.

The system processes the input using the interaction component to produce as output multiple effects of the relationships between the one or more receiver entities and one or more sender entities. The produced output may include a D_{E}×N_{R} matrix E. For example, the input B may be provided to an interaction component, as described above with reference to FIG. 1, that applies a MLP to each column of the input matrix B. The output of the MLP is a D_{E} length vector representing a distributed representation of the effects of the relationships between the receiver entities and sender entities. The N_{R} effects can be concatenates to form the effect matrix E. In some implementations the number of output multiple effects of the relationships between the one or more receiver entities and one or more sender entities may be equal to the number of input relationships between the one or more receiver entities and one or more sender entities.

The multiple effects, e.g., effect matrix E, may be processed together with the states of the one or more receiver entities and one or more sender entities to generate a respective prediction of the future state of each of the one or more receiver entities and one or more sender entities, as described above with reference to step 306 of FIG. 3.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A system comprising one or more computers and one or more storage devices storing instructions that when executed by the one or more computers cause the one or more computers to perform operations comprising:
receiving as input (i) states of one or more receiver entities and one or more sender entities, and (ii) attributes of one or more relationships between the one or more receiver entities and one or more sender entities;
generating an input matrix that comprises, for each of the one or more relationships, a column that represents an interaction vector characterizing (i) the attributes of the relationship, (ii) the sender entity of the relationship, and (iii) the receiver entity of the relationship;
processing the columns of the input matrix using a first neural network to generate an effect matrix that comprises, for each of the one or more relationships, a vector that represents respective effect of the relationship; and
processing (i) the states of the receiver entities and sender entities, and (ii) the effect matrix using a second neural network to produce a second output including a respective prediction of a subsequent state of each of the one or more receiver entities and each of the one or more sender entities.

2. The system of claim 1, wherein a receiver entity comprises an entity that is affected by one or more sender entities through one or more respective relationships.

3. The system of claim 1, wherein a relational attribute of a relationships between a receiver entity and a sender entity describes the relationships between the receiver entity and sender entity.

4. The system of claim 1, wherein the (i) states of the one or more receiver entities and one or more sender entities, and (ii) relational attributes of the one or more relationships between the one or more receiver entities and one or more sender entities are represented as an attributed directed multigraph comprising multiple nodes for each entity and one or more directed edges for each relationships indicating an influence of one entity on another.

5. The system of claim 1, wherein the one or more relationships between the one or more receiver entities and one or more sender entities comprise binary interactions between a receiver entity and a sender entity, and
wherein each binary interaction is represented by a 3-tuple comprising (i) an index of a respective receiver entity, (ii) an index of a respective sender entity, and (iii) a vector containing relational attributes of the respective receiver entity and respective sender entity.

6. The system of claim 1, wherein the one or more relationships between the one or more receiver entities and one or more sender entities comprise high-order interactions, and
wherein each high-order interaction is represented by a (2m−1)-tuple, where m represents the order of the interaction.

7. The system of claim 1, wherein the first neural network comprises a first multilayer perceptron (MLP) and the second neural network comprises a second MLP.

8. The system of claim 7, wherein generating the input matrix comprises:
defining (i) a state matrix as a matrix whose i-th column represents a state of entity i, (ii) a receiver matrix as a N_{O}×N_{R} matrix, where N_{O} represents the total number of entities and N_{R} represents the total number of relationships, and wherein each column of the receiver matrix contains zero entries except for the position of an entity that is a receiver of the corresponding relationships, and (iii) a sender matrix as a N_{O}×N_{R} matrix, wherein each column of the sender matrix contains zero entries except for the position of an entity that is a sender of the corresponding relationships;
multiplying the defined receiver matrix and the defined sender matrix by the defined state matrix; and
concatenating the multiplied matrices to generate the input matrix.

9. The system of claim 8, wherein the relationships between the one or more receiver entities and one or more sender entities comprise relationships of different types, and wherein
concatenating the multiplied matrices further comprises concatenating the multiplied matrices and a matrix representing the relationships of different types.

10. The system of claim 8, wherein processing (i) the states of the receiver entities and sender entities, and (ii) the effect matrix using a second neural network to produce the second output including a respective prediction of the subsequent state of each of the one or more receiver entities and each of the one or more sender entities comprises:
multiplying the effect matrix with a transpose of the defined receiver matrix;
concatenating the multiplied effect matrix with the transpose of the defined receiver matrix with the defined state matrix to generate an input for the second MLP; and
processing the input using the second MLP to produce the second output.

11. The system of claim 8, wherein during a system training process the sender and receiver matrices are constant.

12. The system of claim 1, wherein processing (i) the states of the receiver entities and sender entities, and (ii) the effect matrix using a second neural network to produce the second output comprises aggregating the effects of the relationships between the one or more receiver entities and one or more sender entities using one or more commutative and associative operations, wherein the one or more commutative and associative operations comprise element-wise summations.

13. The system of claim 1, wherein the produced respective prediction of the subsequent state of each of the one or more receiver entities and one or more sender entities comprises multiple entity states corresponding to subsequent receiver entity states and subsequent sender entity states.

14. The system of claim 1, wherein the system is further configured to analyze the produced respective prediction of the subsequent state of each of the one or more receiver entities and one or more sender entities to predict global properties of the one or more receiver entities and one or more sender entities.

15. The system of claim 1, wherein the first neural network and the second neural network are trained independently.

16. The system of claim 1, wherein the first neural network and the second neural network are trained end to end using a gradient based optimization technique.

17. A computer-implemented method comprising:
receiving as input (i) states of one or more receiver entities and one or more sender entities, and (ii) attributes of one or more relationships between the one or more receiver entities and one or more sender entities;
generating an input matrix that comprises, for each of the one or more relationships, a column that represents an interaction vector characterizing (i) the attributes of the relationship, (ii) the sender entity of the relationship, and (iii) the receiver entity of the relationship;
processing the columns of the input matrix using a first neural network to generate an effect matrix that comprises, for each of the one or more relationships, a vector that represents respective effect of the relationship; and
processing (i) the states of the receiver entities and sender entities, and (ii) the effect matrix using a second neural network to produce a second output including a respective prediction of a subsequent state of each of the one or more receiver entities and each of the one or more sender entities.

18. The method of claim 17, wherein a receiver entity comprises an entity that is affected by one or more sender entities through one or more respective relationships.

19. The method of claim 17, wherein a relational attribute of a relationships between a receiver entity and a sender entity describes the relationships between the receiver entity and sender entity.

20. One or more non-transitory computer storage media encoded with instructions that, when executed by one or more computers, cause the one or more computers to perform operations comprising:
receiving as input (i) states of one or more receiver entities and one or more sender entities, and (ii) attributes of one or more relationships between the one or more receiver entities and one or more sender entities;
generating an input matrix that comprises, for each of the one or more relationships, a column that represents an interaction vector characterizing (i) the attributes of the relationship, (ii) the sender entity of the relationship, and (iii) the receiver entity of the relationship;
processing the columns of the input matrix using a first neural network to generate an effect matrix that comprises, for each of the one or more relationships, a vector that represents respective effect of the relationship; and
processing (i) the states of the receiver entities and sender entities, and (ii) the effect matrix using a second neural network to produce a second output including a respective prediction of a subsequent state of each of the one or more receiver entities and each of the one or more sender entities.
